(19) United States
(12) Patent Application Publication
(10) Pub. No.: US 2017/0086202 A1
(43) Pub. Date: Mar. 23, 2017

(54) WI-FI INDOOR RADAR

(71) Applicant: QUALCOMM Incorporated, San Diego, CA (US)

(72) Inventor: Xuetao Chen, Fremont, CA (US)

(21) Appl. No.: 14/860,116

(22) Filed: Sep. 21, 2015

(51) Int. Cl. H04W 72/08; H04L 29/08; H04W 72/04

(52) U.S. Cl. CPC H04W 72/082; H04W 72/0453; H04L 67/30

(57) ABSTRACT

A system and method for object detection in a wireless network. A wireless communications device receives a first set of wireless signals on a first frequency band, and generates a first interference profile for the wireless network based on signal interference in the first set of wireless signals. The wireless communications device further receives a second set of wireless signals on a second frequency band, and generates a second interference profile for the wireless network based on signal interference in the second set of wireless signals. The wireless communications device then detects the presence of an object in the wireless network based at least in part on the first interference profile and the second interference profile.

### TECHNICAL FIELD

The example embodiments relate generally to wireless networks, and specifically to detecting objects in a wireless network environment.

### BACKGROUND OF RELATED ART

Modern intrusion detection or home alarm systems rely on sophisticated sensor technology (e.g., cameras, infrared (IR), and/or other dedicated hardware) to detect human activity. For example, a camera may be used to detect an intruder inside a home. The camera may monitor certain parts of the home, and may trigger an alarm upon detecting a person (e.g., the intruder) within the camera's frame. In another example, an IR sensor may detect a foreign object crossing or passing through an IR channel. For example, the presence of the foreign object in the IR channel may interfere with a transmission of infrared light (e.g., photons) from an IR transmitter to the IR sensor.

The existing sensor technology is typically limited in range and/or requires a direct line-of-sight with the intruder. Moreover, such sensors may not be capable of detecting non-moving bodies or distinguishing between known and unknown persons or objects.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A system and method for object detection in a wireless network is described herein. A wireless communications device receives a first set of wireless signals on a first frequency band, and generates a first interference profile for the wireless network based on signal interference in the first set of wireless signals. The wireless communications device further receives a second set of wireless signals on a second frequency band, and generates a second interference profile for the wireless network based on signal interference in the second set of wireless signals. The wireless communications device then detects the presence of an object in the wireless network based at least in part on the first interference profile and the second interference profile.

In example embodiments, the first set of wireless signals may correspond with wireless local area network (WLAN) signals, and the second set of wireless signals may correspond with ultra-wideband (UWB) signals. For example, the first interference profile may be based on a pattern of Doppler shifts in the first set of wireless signals. Further, the second interference profile may be based on a power profile of the second set of wireless signals. For some embodiments, the wireless communications device may further determine whether the object is moving or stationary based on a combination of the first interference profile and the second interference profile.

The wireless communications device may further receive a third set of wireless signals on a third frequency band, and generate a third interference profile for the wireless network based on the third set of wireless signals. For example, detection of the object in the wireless network may be based on a combination of the first, second, and third interference profiles. In example embodiments, a weighting metric may be applied to each of the first, second, and third interference profiles. For example, the weighting metric may be based at least in part on a signal quality of the respective first, second, and third sets of wireless signals. Still further, for some embodiments, the first frequency band may be a 2.4 GHz frequency band, the second frequency band may be a 60 GHz frequency band, and the third frequency band may be a 5 GHz frequency band.

### BRIEF DESCRIPTION OF THE DRAWINGS

The example embodiments are illustrated by way of example and are not intended to be limited by the figures of the accompanying drawings.

FIG. 1 shows a block diagram of a forward-scattering object detection system, in accordance with example embodiments.

FIG. 2 shows a block diagram of a backscattering object detection system, in accordance with example embodiments.

FIG. 3 shows a block diagram of a multi-frequency object detector, in accordance with example embodiments.

FIG. 4 shows a block diagram of a multi-node object detection system with multi-frequency object detection, in accordance with example embodiments.

FIG. 5 shows a block diagram of a wireless communications device in accordance with example embodiments.

FIG. 6 shows a flowchart depicting an example multi-frequency object detection operation for a wireless communications device.

FIG. 7 shows a flowchart depicting an example operation for detecting a foreign object by combining different interference profiles for received wireless signals.

FIG. 8 shows a flowchart depicting an example operation for detecting a foreign object based on a weighted vote among wireless signals received on multiple frequencies.

### DETAILED DESCRIPTION

The example embodiments are described below in the context of wireless local area network (WLAN) systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (a set of wireless standards, comparable to the IEEE 802.11 standards, used primarily in Europe), and other technologies used in wireless communications. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data packets between wireless devices, the example embodiments may be applied to the exchange of any data unit, packet, and/or frame between wireless devices.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processes and other symbolic representations of operations on data bits within a computer memory. These descriptions and representations are the means used by those skilled in the data processing arts to most effectively convey the substance of their work to other skilled in the art.

The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “calculating,” “monitoring,” “comparing,” “applying,” “updating,” “measuring,” “deriving,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

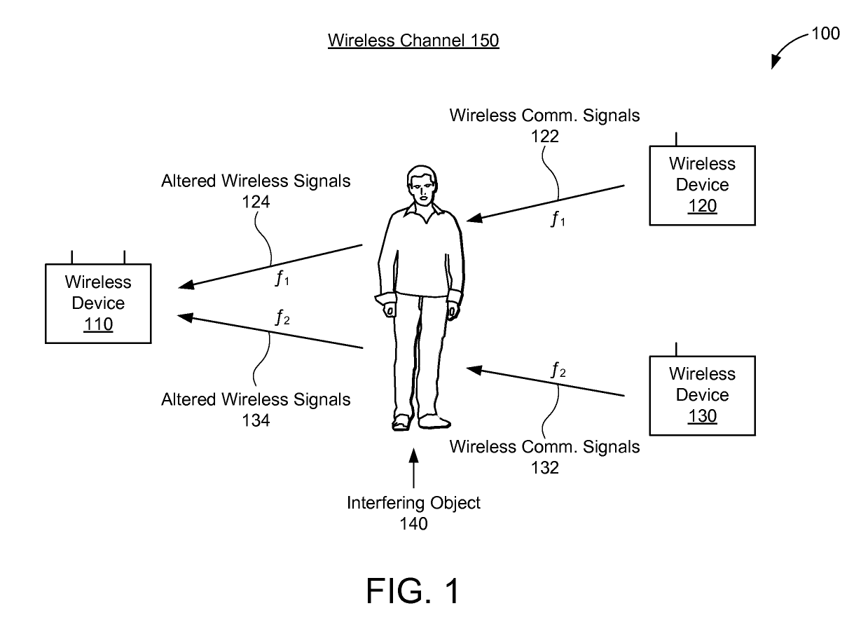

FIG. 1 shows a block diagram of a forward-scattering object detection system 100, in accordance with example embodiments. The forward-scattering object detection system 100 is shown to include wireless devices 110, 120, and 130. In example embodiments, wireless device 110 may form a wireless local area network (WLAN) that may operate according to the IEEE 802.11 family of standards (or according to other suitable wireless protocols). For example, the wireless device 110 may correspond to and/or operate as an access point (AP). The other wireless devices 120 and 130 may communicate with wireless device 110 via a wireless channel 150. For example, the wireless devices 120 and 130 may correspond to wireless stations (STAs) that belong to the WLAN of wireless device 110. Each of the wireless devices 110, 120, and 130 is assigned a unique MAC address that is programmed therein by, for example, the manufacturer of the device.

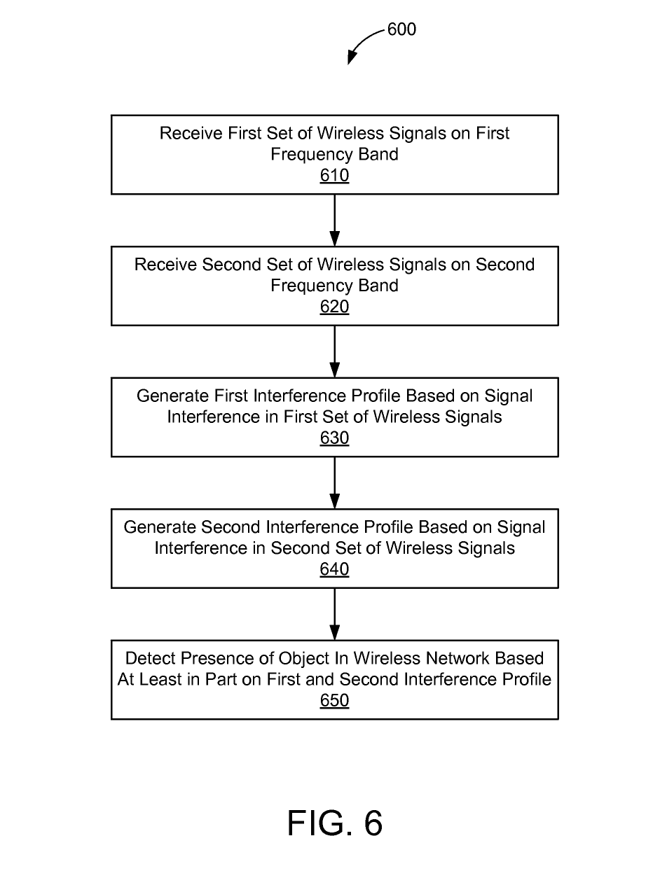

The wireless device 110 may be any suitable device that allows one or more wireless devices to connect to a network (e.g., a local area network (LAN), wide area network (WAN), metropolitan area network (MAN), and/or the Internet) via wireless device 110 using Wi-Fi, Bluetooth, or any other suitable wireless communication standards. In some embodiments, the wireless device 110 may be a wireless station configured as a software-enabled access point (“SoftAP”). For at least one embodiment, wireless device 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6-8.

The other wireless devices 120 and 130 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery).

The one or more transceivers (e.g., for the wireless devices 110, 120, and/or 130) may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band, a 5 GHz frequency band, and/or a 60 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the wireless devices 110, 120 and/or 130 may be any technically feasible transceiver such as a ZigBee transceiver described by a specification from the ZigBee specification, a WiGig transceiver, and/or a HomePlug transceiver described a specification from the HomePlug Alliance.

In example embodiments, the wireless device 110 may detect the presence of physical objects in the wireless channel 150 using a data-compliant (e.g., forward-scattering) “sounding” technique. More specifically, the wireless device 110 may perform object detection based on signal interference in “forward-scattered” wireless signals transmitted from the wireless devices 120 and 130 to wireless device 110. For example, when the wireless devices 120 and 130 transmit respective wireless communication signals 122 and 132 to the wireless device 110, the presence of an interfering object 140 in the wireless channel 150 may alter the path (e.g., propagation delay) and/or power profile of the transmitted signals 122 and 132. As a result, wireless device 110 may receive a set of wireless signals 124 and 134 that are altered from their originally-transmitted form (e.g., as wireless communications signals 122 and 132, respectively), due to object interference in the wireless channel 150. In example embodiments, the wireless device 110 may detect the presence of the interfering object 140 based on an interference profile of (e.g., describing object interference attributable to) the altered wireless signals 124 and 134.

In some examples, the interfering object 140 may be a person walking or otherwise moving through the wireless channel 150. The person's movements may correspond to any type of gesture (e.g., such as the user waving a hand, raising an arm, etc.) or interaction with the wireless channel 150 that causes a detectable pattern of Doppler shifts in received wireless signals. For example, the user's body movements may interfere with wireless signals propagating through the wireless channel 150. Such interference may alter the phase and/or frequency of the wireless signals (e.g., known as “Doppler shifts”) during transmission from a transmitting device (e.g., wireless device 120 and/or 130) to a receiving device (e.g., wireless device 110).

Doppler shifts may be detected and/or characterized in a number of different ways. In one example, Doppler shifts may be detected based on variations in throughput (e.g., packet error rate (PER)) of a received signal. Moreover, different types of movements and/or gestures may produce different patterns of Doppler shifts in the received wireless signals. For example, the change in PER caused by a person walking through the wireless channel 150 may be different than the change in PER caused by a person rotating an arm. Furthermore, different persons may cause different patterns of Doppler shifts in the received wireless signals based on their unique size and/or movements. Thus, in example embodiments, the wireless device 110 may compare a detected pattern of Doppler shifts with known patterns of Doppler shifts (“Doppler signatures”) to determine whether the interfering object 140 is a known object (e.g., homeowner, family member, invited guest, etc.) or a foreign object (e.g., potential intruder).

In example embodiments, the wireless device 110 may detect the pattern of Doppler shifts (e.g., caused by interfering object 140) based on information communicated in the received wireless signals. For example, the wireless communication signals 122 and/or 132 may correspond with a set of data packets defined by the IEEE 802.11 specification. In particular, each data packet includes at least a preamble (e.g., used to delineate the end of the header and start of the data portion of the data packet) and a payload (e.g., the actual data to be communicated between the two devices).

For some embodiments, the wireless device 110 may detect the pattern of Doppler shifts in the received wireless signals based on data in the preambles of received data packets. For example, the IEEE 802.11 standards define a long training field (LTF) to be included in the preamble of every data packet transmitted over a wireless channel. The LTF is typically used for estimating channel state information (CSI) and includes a sequence of training data that is known to the receiver (e.g., wireless device 110). Thus, the wireless device 110 may compare the received training data (e.g., from the preamble) with their known values to determine the effects of the wireless channel 150 (e.g., the Doppler shifts caused by the interfering object 140) on the transmitted data.

For other embodiments, the wireless device 110 may detect the pattern of Doppler shifts in the received wireless signals based on the data in the payload of the received data packets. For example, the payload data may include a set of “sounding data” (e.g., data transmitted for purposes of detecting an interfering object 140) and/or any other data intended to be communicated between the wireless devices 120 and/or 130 and wireless device 110 (e.g., “communications data”). The wireless device 110 may decode the transmitted data bits, use the decoded bits to normalize the received data, and then determine a channel response for the wireless channel 150 (e.g., using zero-forcing equalization techniques). The determined channel response may be representative of the pattern of Doppler shifts caused by the interfering object 140.

In other examples, the interfering object 140 may be a person sleeping or otherwise stationary within the wireless channel 150. More specifically, any movements by the interfering object 140 may not be significant enough to cause a detectable pattern of Doppler shifts in the received wireless signals. However, even relatively imperceptible movements (e.g., such as a person's heartbeat or breathing) may alter the power profile of wireless signals propagating through the wireless channel 150. In example embodiments, ultra-wideband (UWB) signals may be used to detect stationary and/or slow-moving objects in the wireless channel 150.

UWB signaling techniques are typically used for short-range, high-bandwidth communications. More specifically, UWB signals are transmitted as low-energy pulses (e.g., delta function), wherein each pulse occupies the entire UWB bandwidth (e.g., >500 MHz). Accordingly, the power or energy level of the UWB signals may be particularly susceptible to interference in the wireless channel 150. For example, even a person's heartbeat and/or breathing pattern may alter the power profile of UWB signals propagating in the wireless channel 150. Moreover, the heartbeat and/or breathing patterns for different persons may cause different changes to the power profile of received UWB signals. Thus, in example embodiments, the wireless device 110 may compare the power profile of received UWB signals (e.g., in the time domain) with known power profiles (“power signatures”) to determine whether the interfering object 140 is a known object (e.g., homeowner, family member, invited guest, etc.) or a foreign object (e.g., potential intruder).

As described above, different wireless signaling techniques may be better-suited for object detection in different applications. For example, conventional Wi-Fi signals (e.g., as defined by the IEEE 802.11 specification) may be useful for detecting moving objects at greater ranges (e.g., based on the pattern of Doppler shifts in received Wi-Fi signals). However, it may be difficult, if not impossible, to detect Doppler shifts in conventional Wi-Fi signals interacting with stationary or slow-moving objects. On the other hand, UWB signals may be useful for detecting stationary or slow-moving objects at shorter ranges (e.g., based on the power profile of received UWB signals). However, due to their extremely low power, UWB signals may be unusable for wireless communications and/or object detection except at very close distances to the wireless device 110.

In example embodiments, the object detection system 100 may detect the presence of an interfering object 140 based on Doppler shifts in a first set of wireless signals (e.g., altered wireless signals 124) and a power profile of a second set of wireless signals (e.g., altered wireless signals 134). For example, the wireless communications signals 122 transmitted by wireless device 120 may be conventional Wi-Fi signals, and the wireless communications signals 132 transmitted by wireless device 130 may be UWB signals. Thus, the wireless device 110 may analyze a pattern of Doppler shifts in the altered wireless signals 124 and a power profile of the altered wireless signals 134 to detect the presence of the interfering object 140 in the wireless channel 150. As described in greater detail below, by combining multiple object recognition techniques (e.g., Doppler-based object detection and power-based object detection), the wireless device 110 is able to more accurately detect the presence of objects in the wireless channel 150 and distinguish known objects from foreign or unknown objects.

Further, for some embodiments, the wireless devices 120 and 130 may operate on different (e.g., non-overlapping) frequency bands f₁ and f₂, respectively. In particular, the example embodiments recognize that conventional Wi-Fi signals are typically transmitted on a 2.4 GHz frequency band (e.g., as defined by the IEEE 802.11 specification), whereas UWB signals may be well-suited for a 60 GHz frequency band (e.g., due to high bandwidth and short range requirements). Thus, in example embodiments, wireless signals 122 and 124 may be transmitted via the first frequency band f₁ (e.g., the 2.4 GHz frequency band), and wireless signals 132 and 134 may be transmitted via the second frequency band f₂ (e.g., the 60 GHz frequency band). As described in greater detail below, using wireless signals from multiple frequency bands may further increase the accuracy of object detection, for example, by hedging the risk of wireless interference (e.g., interference caused by other wireless signals and/or radiation) on any particular frequency band.

By implementing a data-compliant (e.g., forward-scattering) sounding technique, as described above with respect to FIG. 1, the wireless device 110 may detect the interfering object 140 in the wireless channel 150 without interrupting data communications with the wireless devices 120 and 130, and/or other wireless devices (not shown) in the wireless network. Moreover, in example embodiments, the wireless device 110 may analyze the interference profiles (e.g., Doppler shift patterns and/or power profiles) for the altered wireless signals 124 and 134 while simultaneously or concurrently processing data received from the wireless signals 124 and 134. For example, the wireless device 110 may analyze the preamble information of a received data packet to detect the presence of the interfering object 140 in the wireless channel 150 while concurrently processing payload data form the received data packet.

The example embodiments further recognize that it may not always be practical (or feasible) to implement a data-compliant sounding technique. For example, a large amount of noise and/or other interference in the wireless channel 150 may reduce the signal-to-noise ratio (SNR) (e.g., or signal-to-interference-plus-noise ratio (SINR)) of wireless communications between the wireless device 110 and wireless devices 120 and/or 130. Thus, significant amounts of noise in the wireless channel 150 may make it difficult, if not impossible, for the wireless device 110 to properly recover the data transmitted on the wireless communication signals 122 and 132 and/or to generate accurate interference profiles based on the altered wireless signals 124 and 134.

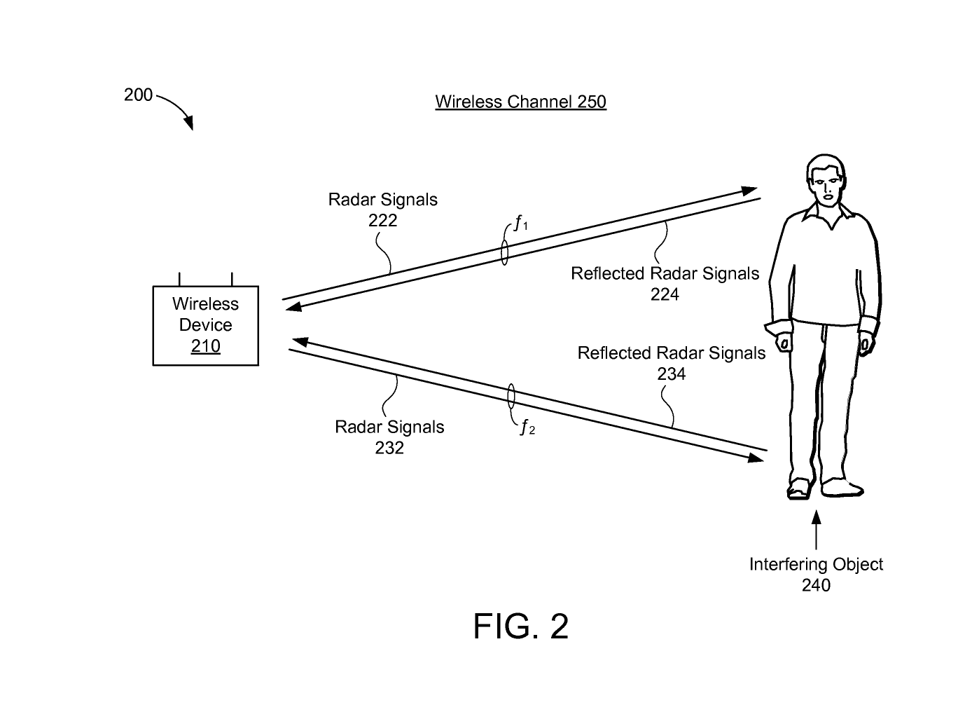

FIG. 2 shows a block diagram of a backscattering object detection system 200, in accordance with example embodiments. The backscattering object detection system 200 is shown to include a wireless device 210. For purposes of discussion, the wireless device 210 may be an embodiment of wireless device 110 of FIG. 1. Thus, although not shown for simplicity, the wireless device 210 may form a wireless network (e.g., WLAN) that includes additional wireless devices (e.g., wireless devices 120 and/or 130 of FIG. 1).

In example embodiments, the wireless device 210 may detect the presence of physical objects in the wireless channel using radar-based (e.g., backscattering) sounding techniques. More specifically, the wireless device 210 may perform object detection based on signal interference in “backscattered” wireless that are transmitted by the wireless device 210 and subsequently reflected back to the wireless device 210 (e.g., by an interfering object 240 in a wireless channel 250). For example, the wireless device 210 may transmit or broadcast radar signals 222 and 232 in the wireless channel 250 and measure the reflected signals 224 and 234, respectively, to detect and/or identify objects in the wireless channel 250. The interfering object 240 in the wireless channel 150 may alter the phase, frequency, and/or power of the radar signals 222 and 232. As a result, the wireless device 210 receives the reflected radar signals 224 and 234 with altered characteristics that may be attributed to the presence of the interfering object 140.

The wireless device 210 may transmit the first set of radar signals 222, on a first frequency band f₁ (e.g., the 2.4 GHz frequency band), using Doppler-radar signaling techniques. Thus, the wireless device 210 may directly measure the Doppler shifts caused by the interfering object 240 in the reflected radar signals 224. For example, the radar signals 222 may be un-modulated continuous-wave (CW) radar signals (e.g., containing a single frequency or signal tone) that are typically used in detecting object velocity. Alternatively, pulse-compression techniques may be used in generating the radar signals 222 (e.g., to increase SNR and/or reduce interference and interruptions to data communication systems).

For some embodiments, the wireless device 210 may broadcast single-tone (e.g., un-modulated) CW radar signals 222 and detect the pattern of Doppler shifts in the reflected (e.g., backscattered) radar signals 224. For example, the wireless device 210 may detect the Doppler shifts by measuring the phase difference between the transmission of the radar signals 222 and the reception of the reflected radar signals 224. The interfering object 140 may introduce a low frequency sinusoidal modulation on the amplitudes of real and/or imaginary parts of successive radar signals 222. The amplitude variations may thus be indicative of the Doppler shifts in the reflected radar signals 224. Although single-tone CW radar signals may be relatively simple to implement (e.g., in terms of cost and/or complexity), single-tone CW radar signals tend to be limited in range and application (e.g., single-tone CW radar signals may only be used to detect object velocity).

For other embodiments, the wireless device 210 may use pulse compression to modulate the radar signals 222 and detect the pattern of Doppler shifts in the reflected radar signals 224. For example, the wireless device 210 may modulate the radar signals 222 using a frequency “chirp” modulation scheme (e.g., by varying the frequency of the radar signals 222 based on a predetermined pattern) or using pseudo-random noise (PN) coding (e.g., by encoding the radar signals 222 with a predetermined PN sequence). The modulated radar signals 222 may be used to detect objects (e.g., interfering object 240) at longer rangers than single-tone CW radar signals. Moreover, the additional layer of information introduced into the radar signals 222 through pulse compression may be used to determine the distance to the object, in addition to its velocity. Thus, although pulse compression radar signals may be more expensive and/or complex to implement (e.g., than single-ton CW radar signals), pulse compression radar signals may also be used to detect a greater range of gestures and/or movements.

The wireless device 210 may transmit the second set of radar signals 232, on a second frequency band f₂ (e.g., the 60 GHz frequency band), using UWB-radar signaling techniques. As described above, UWB signals are transmitted as narrow pulses. Thus, by convention, UWB signals are particularly well-suited for radar-based sounding applications. For some embodiments, the wireless device 210 may broadcast UWB signals 232 and detect a power profile of the reflected (e.g., backscattered) UWB signals 234. As described above, the presence of an interfering object 240 (e.g., whether stationary or slow-moving) may cause changes in the power profile of the reflected signals 234. The wireless device 210 may thus detect the presence of the interfering object 240 in the wireless channel 250 based on the changes in the power profile of the reflected signals 234.

As described above, distributing the radar signals 222 and 232 across multiple frequency bands may hedge the risk of wireless interference on any particular frequency band. Furthermore, combining multiple object recognition techniques (e.g., Doppler-based object detection and power-based object detection) allows the wireless device 210 to more accurately detect the presence of objects in the wireless channel 250 and distinguish known objects from foreign or unknown objects.

By implementing a radar-based sounding technique (e.g., backscattering) sounding technique, as described above with respect to FIG. 2, the wireless device 210 may detect a greater range of objects and/or more accurately detect the interfering object 240 in the wireless channel 250, even when a substantial amount of noise is present in the wireless channel 250. However, because radar-based sounding techniques depend on the use of radar signals 222 and 232 (e.g., as opposed to wireless communication signals 122 and 132), the wireless device 210 may need to temporarily pause data communications with other wireless devices (not shown) in the wireless network when performing radar-based object detection (e.g., unless the wireless device 210 includes a separate wireless radio for transmitting and receiving radar signals 222).

Thus, in some example embodiments, a wireless device performing object detection may dynamically switch between data-compliant (e.g., forward-scattering) sounding techniques and radar-based (e.g., backscattering) sounding techniques depending on the amount of noise in the wireless channel. For example, the wireless device may select the data-compliant sounding technique when the SNR (or SINR) of the wireless channel is above a threshold SNR level (e.g., the amount of noise and/or interference in the wireless channel is below a threshold noise level). The wireless device may select the radar-based sounding technique when the SNR (or SINR) of the wireless channel is at or below the threshold SNR level (e.g., the noise and/or interference in the wireless channel is at or above a threshold noise level).

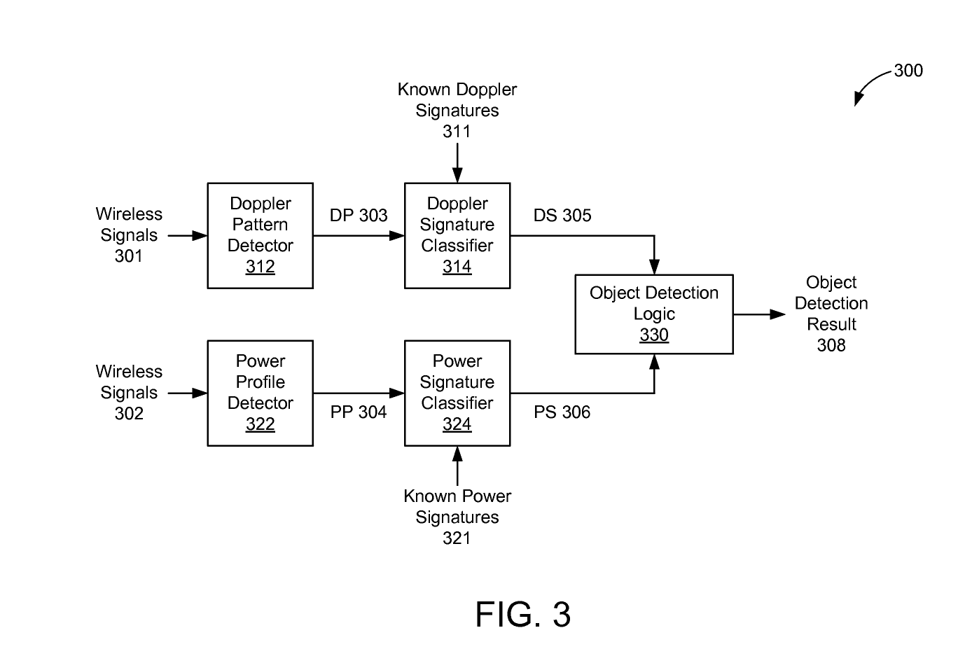

FIG. 3 shows a block diagram of a multi-frequency object detector 300, in accordance with example embodiments. The multi-frequency object detector 300 may be implemented by wireless device 110 of FIG. 1 and/or wireless device 210 of FIG. 2 to detect the presence of physical objects (e.g., such as persons and/or intruders) in a wireless channel. The object detector 300 includes a Doppler pattern detector 312, a Doppler signature classifier 314, a power profile detector 322, a power signature classifier 324, and object detection logic 330. The object detector 300 may perform object detection based on received wireless signals 301 and 302, and in response thereto generate an object detection result 308 based on the presence of known and/or foreign objects in the wireless channel.

The Doppler pattern detector 312 receives a first set of wireless signals 301 via the wireless channel and detects a pattern of Doppler shifts (DP or Doppler Pattern) 303 in the received signals 301. For example, the wireless signals 301 may include data signals transmitted, on a first frequency band f₁ (e.g., the 2.4 GHz frequency band), by one or more wireless devices in a wireless network (e.g., as described above with respect to FIG. 1). Thus, the Doppler pattern detector 312 may detect the pattern of Doppler shifts 303 based on data communicated in the wireless signals 301 (e.g., preamble and/or payload information). Alternatively, and/or in addition, the wireless signals 301 may include backscattered radar signals transmitted by a device on which the object detector 300 resides (e.g., as described above with respect to FIG. 2). Thus, for some implementations, the Doppler pattern detector 312 may detect the pattern of Doppler shifts 303 based on changes in the round-trip times and/or phases between successive wireless signals in each set of wireless signals 301.

The Doppler signature classifier 314 receives the Doppler pattern 303 from the Doppler pattern detector 312 and compares the pattern with a set of known Doppler signatures 311. For example, the Doppler signature classifier 314 may compare the Doppler pattern 303 with a set of predetermined Doppler patterns or signatures 311 that are known or recognized by the object detector 300 (e.g., through a training process). More specifically, each known Doppler signature 311 may be associated with a particular state or condition of a user's home. For example, the object detector 300 may store known Doppler signatures 311 for an empty house, a house with the user (e.g., homeowner) present, a house with one or more family members (e.g., including pets) present, a house with one or more guests present, and/or any other conditions that the user may have indicated to be “safe.”

Thus, the object detector 300 may be able to recognize only a finite set of Doppler signatures 311. For some embodiments, if the Doppler signature classifier 314 is able to match the Doppler pattern 303 with a known Doppler signature 311, the Doppler signature classifier 314 may output a Doppler signature (DS) 305 (e.g., for the received wireless signals 301) that corresponds with the known Doppler signature 311. However, if the Doppler signature classifier 314 is unable to match the Doppler pattern 303 with any known Doppler signatures 311, the Doppler signature classifier 314 may output a null value (e.g., indicating no match was detected) for the Doppler signature 305.

The power profile detector 322 receives a second set of wireless signals 302 via the wireless channel and detects a power profile (PP) 304 of the received signals 302. More specifically, the power profile detector 322 may detect the power profile 304 by measuring the power and/or energy levels of the received signals 302 (e.g., in the time domain). For example, the wireless signals 302 may include UWB signs transmitted, on a second frequency band f₂ (e.g., the 60 GHz frequency band), by one or more wireless devices in the wireless network (e.g., as described above with respect to FIG. 1). Alternatively, and/or in addition, the wireless signals 302 may include backscattered UWB signals transmitted by the device on which the object detector 300 resides (e.g., as described above with respect to FIG. 2).

The power signature classifier 324 receives the power profile 304 from the power profile detector 322 and compares the profile with a set of known power signatures 321. For example, the power signature classifier 324 may compare the power profile 304 with a set of predetermine power profiles or signatures 321 that are known or recognized by the object detector 300 (e.g., through a training process). More specifically, each known power signature 321 may be associated with a particular state or condition of the user's home. For example, the object detector 300 may store known power signatures 321 for an empty house, a house with the user present, a house with one or more family members present, a house with one or more guests present, and/or any other conditions that the user may have indicated to be “safe.”

Thus, the object detector may recognize only a finite set of power signatures 321. For some embodiments, if the power signature classifier 324 is able to match the power profile 304 with a known power signature 321, the power signature classifier 324 may output a power signature (PS) 306 (e.g., for the received wireless signals 302) that corresponds with the known power signature 321. However, if the power signature classifier 324 is unable to match the power profile 304 with any known power signatures 321, the power signature classifier 324 may output a null value (e.g., indicating no match was detected) for the power signature 306.

The object detection logic 330 receives the Doppler signature 305 from the Doppler signature classifier 314 and the power signature 306 from the power signature classifier 324, and compares the two signatures to determine whether an object is present in the wireless channel. In example embodiments, the object detection logic 330 may determine whether the wireless channel is in a known state (e.g., indicating that the user's house is “safe”) or an unknown state (e.g., indicating that there may be a potential intruder or unknown person inside the user's home). For example, the results of the determination may be summarized by Table 1, below.

TABLE 1

| | Known DS | Null DS |
|---|---|---|
| Known PS | Safe | Foreign Object |
| | | (Moving, Far Away) |
| Null PS | Foreign Object | Foreign Object |
| | (Stationary, Close By) | (Moving, Close By) |

With reference to Table 1, if both the Doppler signature 305 and the power signature 306 indicate known values, the wireless channel may be in a known or recognized state (e.g., the wireless channel is in a “safe” condition). However, if any of the signatures (e.g., Doppler signature 305 and/or power signature 306) returns a null (or unknown) value, there may potentially be a foreign object (e.g., an intruder or unknown person or animal) in the wireless channel.

For example, if the Doppler signature 305 indicates a known value, but the power signature 306 is a null value, the foreign object may be stationary (e.g., since the object was not detected using Doppler-based object recognition techniques) and within close proximity, or a threshold distance, of the object-detecting device (e.g., since the object was detected using short-range UWB signals). If the power signature 306 indicates a known value, but the Doppler signature 305 is a null value, the foreign object may be moving (e.g., since the object was detected using Doppler-based object recognition techniques) and relatively far, or a threshold distance, away from the object-detecting device (e.g., since the object was not detected using short-range UWB signals). If the Doppler signature 305 and the power signature 306 are null values, the foreign object may be moving (e.g., since the objected was detected using Doppler-based object recognition techniques) and within close proximity, or a threshold distance, of the object-detecting device (e.g., since the object was also detected using short-range UWB signals).

The object detection results 308 may indicate one of the states of the wireless channel described above, with respect to Table 1. For some embodiments, the object detector 300 may be used in burglar alarm or intrusion-detection applications. For example, the object detection logic 330 may trigger or activate an alarm upon detecting a moving foreign object within close proximity of the object-detecting device (e.g., both Doppler signature 305 and power signature 306 return null values). Because the foreign object is within close proximity of the object-detecting device, it is most likely inside the user's home. Further, because the foreign object is moving, it has the potential to burglarize the home and/or cause harm to other residents inside the home.

For some embodiments, the object detection logic 330 may not trigger or activate the alarm if it detects a stationary foreign object within close proximity of the object-detecting device (e.g., Doppler signature 305 returns a known value and power signature 306 returns a null value). Because the foreign object is within close proximity of the object-detecting device, it is most likely inside the user's home. However, because the foreign object is stationary, it is unlikely to burglarize the home and/or cause harm to other residents inside the home. For example, the foreign object may be a new (e.g., unrecognized) guest or pet sleeping inside the user's home.

For some embodiments, the object detection logic 330 may not trigger or activate the alarm if it detects a moving foreign object farther away from the object-detecting device (e.g., power signature 306 returns a known value and Doppler signature 305 returns a null value). Because the foreign object is relatively far from the object-detecting device, it may be outside the user's home. Moreover, because the foreign object is moving, it may simply be a person or animal passing in front of (or behind) the user's house (e.g., such as a courier or a squirrel).

The alarm-triggering examples described above are for illustrative purposes only. In actual implementations, the conditions for triggering an alarm may be user-programmable, and may therefore vary depending on the implementation. For example, if the user is away from the home (and there are no pets inside the home), the user may configure the object detector 300 to activate an alarm if any motion is detected inside the home (e.g., without first determining whether the motion is from a known object or a foreign object).

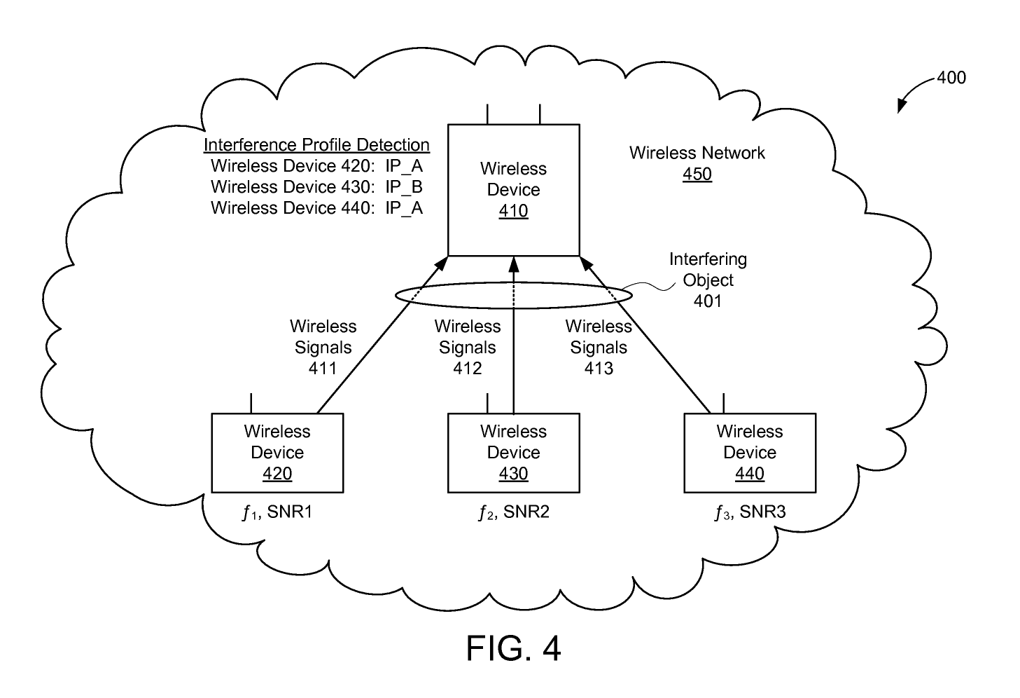

FIG. 4 shows a block diagram of a multi-node object detection system 400 with multi-frequency object detection, in accordance with example embodiments. The object detection system 400 is shown to include a number of wireless devices 410-440, and a wireless network 450. For purposes of discussion, the wireless device 410 may be one embodiment of wireless device 110 of FIG. 1 and/or wireless device 210 of FIG. 2. Furthermore, each of the remaining wireless devices 420-440 may be an embodiment of either wireless device 120 or wireless device 130 of FIG. 1. The wireless network 450 may be formed by a plurality of Wi-Fi APs that may operate according to the IEEE 802.11 family of standards (or according to other suitable wireless protocols). Thus, in example embodiments, the wireless device 410 may operate as an AP (or SoftAP). Further, it is to be understood that the wireless network 450 may be formed by any number of access points such as wireless device 410.

In example embodiments, each of the wireless devices 420-440 operates on a different frequency band f₁-f₃, respectively. However, for simplicity, the wireless devices 420-440 may all use the same communications or signaling technique (e.g., conventional Wi-Fi signaling or UWB signaling). For example, wireless device 420 may transmit Wi-Fi signals (e.g., wireless signals 411) on a 2.4 GHz frequency band (e.g., f₁), wireless device 430 may transmit Wi-Fi signals (e.g., wireless signals 412) on a 5 GHz frequency band (e.g., f₂), and wireless device 440 may transmit Wi-Fi signals (e.g., wireless signals 413) on a 60 GHz frequency band (e.g., f₃). The different frequency bands f₁-f₃ are likely to experience different levels of wireless interference.

For example, the 2.4 GHz frequency band is one of the most commonly-used frequency bands for wireless communications, and therefore tends to be the most crowded. Higher frequency bands offer greater bandwidth and tend to be less crowded, but are generally more limited in range. For example, the 5 GHz frequency band is likely to experience less wireless interference than the 2.4 GHz frequency band, but has a shorter communications range. Further, the 60 GHz frequency band is likely to experience less wireless interference than the 5 GHz frequency band, but may have an even shorter communications range.

The wireless device 410 may detect an interfering object 401 in the wireless network 450 based on interference profiles (e.g., Doppler shift patterns and/or power profiles) of wireless signals 411-413 received from each of the wireless devices 420-440, respectively. As described above, the interfering object 401 may cause detectable changes to the phase, frequency, and/or power of each of the wireless signals 411-413. However, depending on the relative positions of the wireless devices 420-440 with respect to wireless device 410 and/or channel conditions (e.g., noise, interference, etc.), the wireless signals 411-413 may not all exhibit the same interference profile (e.g., even if the same object recognition technique is used on each of the wireless signals 411-413). More specifically, the movement and/or position of the interfering object 401 may affect individual wireless signals 411-413 differently.

For example, the wireless device 410 may generate a first interference profile (IP_A) for the wireless network 450 based on the wireless signals 411 and 413 transmitted by wireless devices 420 and 440, respectively. Further, the wireless device 410 may generate a second interference profile (IP_B) for the wireless network 450 based on the wireless signals 412 transmitted by wireless device 430. Accordingly, there are two “unique” interference profiles for the wireless network 450 (e.g., IP_A and IP_B). The first interference profile IP_A and the second interference profile IP_B may represent different Doppler signatures or different power signatures (and thus different object recognition results) for the interfering object 401. Thus, in example embodiments, the wireless device 410 may select one of the interference profiles IP_A or IP_B to be representative of the interfering object 401.

For some embodiments, the wireless device 410 may select the representative interference profile based, at least in part, on a “majority vote.” For example, the wireless device 410 may select the most popular or most commonly-detected interference profile among the plurality of wireless devices 420-440 to be the representative interference profile. In the example shown in FIG. 4, wireless signals 411 and 413 from wireless devices 420 and 440, respectively, both exhibit the first interference profile IP_A, whereas only the wireless signals 412 from wireless device 430 exhibit the second interference profile IP_B. Thus, based solely on majority vote, the wireless device 410 may select the first interference profile IP_A to be representative of the interfering object 401.

For other embodiments, the wireless device 410 may select the representative interference profile based, at least in part, on a respective signal quality of each of the received wireless signals 411-413. For example, the wireless device 410 may select the interference profile associated with the wireless device 420, 430, or 440 that exhibits the highest SNR (or SINR). In the example shown in FIG. 4, the wireless channel between wireless device 410 and wireless device 420 may be characterized by a first SNR (SNR1), the wireless channel between wireless device 410 and wireless device 430 may be characterized by a second SNR (SNR2), and the wireless channel between the wireless device 410 and wireless device 440 may be characterized by a third SNR (SNR3).

As described above, the SNR values SNR1-SNR3 may vary depending on the relative positions of the wireless device 420-440 (e.g., in relation to wireless device 410) and the frequency bands f₁-f₃, respectively, in which they operate. For purposes of discussion, wireless signals 412 may have a higher signal quality than wireless signals 411 and 413 (e.g., SNR2>SNR1 and SNR2>SNR3). Thus, based solely on signal quality, the wireless device 410 may select the second interference profile IP_B (detected from wireless signals 412) to be representative of the interfering object 401.

Still further, for some embodiments, the wireless device 410 may select the representative interference profile based on a combination of factors such as, but not limited to, a majority vote and a respective signal quality of each of the received wireless signals 411-413. For example, the wireless device 410 may first determine the interference profiles “voted on” by each of the wireless devices 420-440. In the example of FIG. 4, wireless devices 420 and 440 vote for the first interference profile IP_A, whereas wireless device 430 votes for the second interference profile IP_B. The wireless device 410 may then assign a weighting metric to each vote based on the SNR exhibited by each of the respective wireless devices 420-430. In this example, the votes cast by wireless devices 420 and 440 may each be assigned a weight of 2 (e.g., SNR1=SNR3), whereas the vote cast by wireless device 430 may be assigned a weight of 3 (e.g., SNR2>SNR1 and SNR2>SNR3). These example voting results are summarized in Table 2, below.

TABLE 2

| Wireless | | |
|---|---|---|
| Device | Vote | Weight |
| 420 | IP_A | 2 |
| 430 | IP_B | 3 |
| 440 | IP_A | 2 |

As a result, 4 votes are effectively cast for the first interference profile IP_A, whereas only 3 votes are effectively cast for the second interference profile IP_B. Thus, in this example, the wireless device 410 may select the first interference profile IP_A to be representative of the interfering object 401. In the event of a tie, the wireless device 410 may use one or more voting criteria to break the tie. For example, Table 3 illustrates an example scenario in which there is a tie between the first interference profile IP_A and the second interference profile IP_B (e.g., both IP_A and IP_B have a total of 2 effective votes).

TABLE 3

| Wireless | | |
|---|---|---|
| Device | Vote | Weight |
| 420 | IP_A | 1 |
| 430 | IP_B | 2 |
| 440 | IP_A | 1 |

In some embodiments, the wireless device 410 may select the most common interference profile, among those involved in the tie, to be the representative of the interfering object 401. For example, with reference to Table 3, the first interference profile IP_A is detected from wireless signals (e.g., wireless signals 411 and 413) transmitted by two different wireless devices (e.g., wireless devices 420 and 440, respectively), whereas the second interference profile IP_B is detected from wireless signals (e.g., wireless signals 412) transmitted by only one wireless device (e.g., wireless device 430). Thus, based on the aforementioned tiebreak criteria, the wireless device 410 may select the first interference profile IP_A to be representative of the interfering object 401.

In other embodiments, the wireless device 410 may select the interference profile associated with the single highest weighting metric, among those involved in the tie, to be the representative interference profile for the interfering object 401. For example, with reference to Table 3, the single highest weight assigned to the second interference profile IP_B is 2 (e.g., based on the vote by wireless device 430), whereas the single highest weight assigned to the first interference profile IP_A is 1 (e.g., based on votes by wireless devices 420 and 440). Thus, based on the aforementioned tiebreak criteria, the wireless device 410 may select the second interference profile IP_B to be representative of the interfering object 401.

Still further, the wireless device 410 may implement various combinations of tiebreaking criteria that may include, but are not limited to, any of the criteria described above. For example, in an alternative embodiment, the vote cast by a predetermined one of the wireless devices 420, 430, and 440 may always be used to determine the representative interference profile in the event of a tie.

Upon determining the representative interference profile (e.g., which may be a representative Doppler pattern or a representative power profile), the wireless device 410 may classify the corresponding pattern of Doppler shifts or power profile as a respective Doppler signature or power signature (e.g., as described above with respect to FIG. 3). In example embodiments, the wireless device 410 may determine whether the detected object 401 is a known object or a foreign object based on whether the Doppler signature or power signature classification is known or unknown to the wireless device 410.

For some embodiments, the wireless device 410 may determine both a representative Doppler pattern and a representative power profile based on a plurality of wireless signals received from the wireless devices 420-440 and/or additional wireless devices (not shown for simplicity) in the wireless network 450. Combining the Doppler signature with the power signature may allow the wireless device 410 to determine a number of additional characteristics about the interfering object 401, such as, for example: whether the interfering object 401 is a known object or a foreign object, whether the interfering object 401 is moving or stationary, and/or the relative proximity of the interfering object to the wireless device 410 (e.g., as described above with respect to FIG. 3).

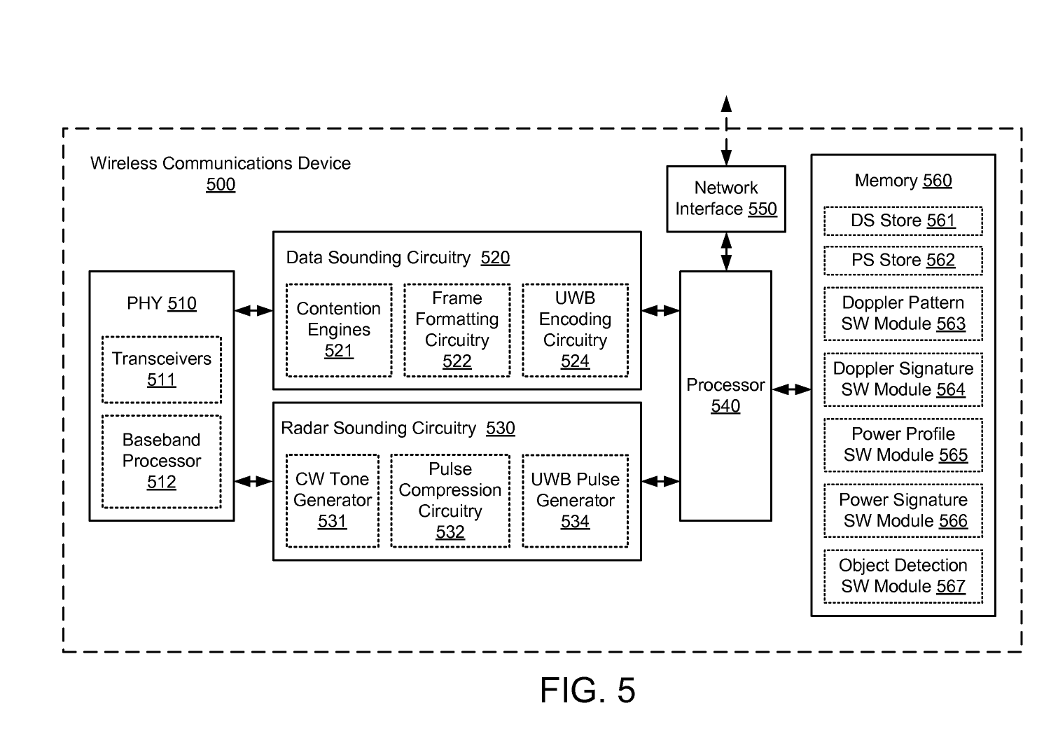

FIG. 5 shows a block diagram of a wireless communications device 500 in accordance with example embodiments. The device 500 may be one embodiment of the wireless device 110 of FIG. 1, wireless device 210 of FIG. 2, and/or wireless device 410 of FIG. 4. The device 500 includes at least a PHY device 510, data sounding circuitry 520, radar sounding circuitry 530, a processor 540, a network interface 550, and memory 560. In some examples, the data sounding circuitry 520 and radar sounding circuitry 530 may reside within the PHY device 510. In example embodiments, the device 500 may belong to a wireless object detection system (not shown for simplicity) formed, at least in part, by a network of wireless devices. For example, the network interface 550 may be used to communicate with a WLAN server either directly or via one or more intervening networks, and to transmit signals.

The PHY device 510 includes at least a set of transceivers 511 and a baseband processor 512. The transceivers 511 may be coupled to a plurality of antennas (not shown for simplicity) either directly or through an antenna selection circuit (also not shown). The transceivers 511 may be used to transmit signals to and receive signals from other wireless devices (e.g., APs and/or STAs), and may be used to scan the surrounding environment to detect and identify nearby wireless devices (e.g., within wireless range of the wireless communications device 500). The baseband processor 512 may be used to process signals received from processor 540 and/or memory 560 and to forward the processed signals to transceivers 511 for transmission via one or more antennas. The baseband processor 512 may also be used to process signals received from the one or more antennas via transceivers 511 and to forward the processed signals to the processor 540 and/or memory 560.

For purposes of discussion herein, the data sounding circuitry 520 and radar sounding circuitry 530 are shown in FIG. 5 as being coupled between the PHY device 510 and processor 540. However, for actual embodiments, PHY device 510, data sounding circuitry 520, radar sounding circuitry 530, processor 540, network interface 550, and/or memory 560 may be connected together using one or more buses (not shown for simplicity).

The data sounding circuitry 520 includes at least a set of contention engines 521, frame formatting circuitry 522, and UWB encoding circuitry 524. The contention engines 521 may contend for access to a shared wireless medium, and may also store packets for transmission over the shared wireless medium. For some embodiments, the contention engines 521 may be implemented as one or more software modules (e.g., stored in memory 560 or stored in memory provided within the data sounding circuitry 520) containing instructions that, when executed by processor 540, perform the functions of the contention engines 521. The frame formatting circuitry 522 may be used to create and/or format frames received from the processor 540 and/or memory 560 (e.g., by adding MAC headers to data packets provided by processor 540), and may be used to re-format frames received from the PHY device 510 (e.g., by stripping MAC headers from frames received from the PHY device 510). The UWB encoding circuitry 524 may be used to encode outgoing data received from the processor 540 and/or memory 560 as a series of UWB pulses (e.g., a delta function), and may be used to decode UWB pulses received from the PHY device 510.

The radar sounding circuitry 530 includes at least a continuous wave (CW) tone generator 531, pulse compression circuitry 532, and UWB pulse generator 534. The CW tone generator 531 may generate single-tone radar signals at a particular radar frequency. The pulse compression circuitry 532 may modulate the radar signals generated by the CW tone generator 531, for example, using pulse compression techniques. For some embodiments, the pulse compression circuitry 532 may modulate the radar signals using a frequency chirp modulation scheme. For other embodiments, the pulse compression circuitry 532 may modulate the radar signals using PN coding. For still other embodiments, the pulse compression circuitry 532 may be implemented as one or more software modules (e.g., stored in memory 560 or stored in memory provided within the radar sounding circuitry 530) containing instructions that, when executed by processor 540, perform the functions of the pulse compression circuitry 532. The UWB pulse generator 534 may generate UWB radar signals at a UWB frequency.

Memory 560 may include a Doppler signature (DS) store 561 and a power signature (PS) store 562. The DS store 561 may store data corresponding to Doppler signatures that are known and/or recognized by the device 500. For example, the stored Doppler signatures may be used to classify a pattern of Doppler shifts detected in a set of wireless signals received via the PHY device 510 (e.g., as described above with respect to FIG. 3). The PS store 562 may store data corresponding to power profiles that are known and/or recognized by the device 500. For example, the stored power signatures may be used to classify a power profile of a set of wireless signals received via the PHY device 510 (e.g., as described above with respect to FIG. 3).

Memory 560 may also include a non-transitory computer-readable medium (e.g., one or more nonvolatile memory elements, such as EPROM, EEPROM, Flash memory, a hard drive, and so on) that may store at least the following software (SW) modules:
a Doppler pattern SW module 563 to detect a pattern of Doppler shifts in a first set of wireless signals received by the device 500 (e.g., via PHY device 510);
a Doppler signature SW module 564 to classify the detected pattern of Doppler shifts based on a set of known Doppler signatures (e.g., stored by the DS store 561);
a power profile SW module 565 to detect a power profile of a second set of wireless signals received by the device 500 (e.g., via PHY device 510);
a power signature SW module 566 to classify the detected power profile based on a set of known power signatures (e.g., stored by the PS store 562); and
an object detection SW module 567 to detect the presence of an interfering object (e.g., known or foreign) in the wireless channel based on results of the Doppler signature classification and the power signature classification.
   Each software module includes instructions that, when executed by processor 540, cause the device 500 to perform the corresponding functions. The non-transitory computer-readable medium of memory 560 thus includes instructions for performing all or a portion of the operations depicted in FIGS. 6-8.

The processor 540 may be any suitable one or more processors capable of executing scripts or instructions of one or more software programs stored by the wireless communications device 500 (e.g., within memory 560). For example, processor 540 may execute the Doppler pattern SW module 563 to detect a pattern of Doppler shifts in a first set of wireless signals received by the device 500 (e.g., via PHY device 510). The processor 540 may further execute the Doppler signature SW module 564 to classify the detected pattern of Doppler shifts based on a set of known Doppler signatures (e.g., stored by the DS store 561).

Processor 540 may execute the power profile SW module 565 to detect a power profile of a second set of wireless signals received by the device 500 (e.g., via PHY device 510). The processor 540 may further execute the power signature SW module 566 to classify the detected power profile based on a set of known power signatures (e.g., stored by the PS store 562). Still further, processor 540 may execute the object detection SW module 567 to detect the presence of an interfering object (e.g., known or foreign) in the wireless channel based on results of the Doppler signature classification and the power signature classification.

FIG. 6 shows an illustrative flowchart depicting an example multi-frequency object detection operation 600 for a wireless communications device. With reference, for example, to FIG. 5, the operation 600 may be performed by the wireless communications device 500 to detect the presence of an interfering (e.g., physical object) in a wireless channel.

The device 500 receives a first set of wireless signals on a first frequency band (610) and receives a second set of wireless signals on a second frequency band (620). As described above, different frequency bands may exhibit different channel characteristics which may affect the first and second wireless signals differently (e.g., based on noise, wireless interference, and/or other channel properties). Thus, performing object detection based on wireless signals received on different frequency bands may increase the accuracy of object detection, for example, by hedging the risk of wireless interference on any particular frequency band.

For some embodiments, the first set of wireless signals may correspond to conventional Wi-Fi communication signals transmitted by a first transmitting device and the second set of wireless signals may correspond to UWB communications signals transmitted by a second transmitting device (e.g., as described above with respect to FIG. 1). For other embodiments, the first set of wireless signals may correspond to reflect Doppler radar signals transmitted by the device 500 and the second set of wireless signals may correspond to reflected UWB radar signals also transmitted by the device 500 (e.g., as described above with respect to FIG. 2). Still further, for some embodiments, both the first and second sets of wireless signals may be transmitted using the same signaling technique, but on different frequencies (e.g., as described above with respect to FIG. 4)

The device 500 generates a first interference profile based on signal interference in the first set of wireless signals (630) and generates a second interference profile based on signal interference in the second set of wireless signals (640). The first and second interference profiles may depend on the type and/or frequency of the first and second sets of received wireless signals, respectively. For example, if the received set of wireless signals corresponds to a set of conventional Wi-Fi communication signals or Doppler radar signals, the processor 540 may execute the Doppler pattern SW module 563 to detect a pattern of Doppler shifts in the first set of wireless signals. If the received set of wireless signals corresponds to a set of UWB communication signals or UWB radar signals, the processor 540 may execute the power profile SW module 565 to detect a power profile of the first set of wireless signals.

The device 500 may then detect the presence of an object in the wireless network based at least in part on the first and second interference profiles (650). In example embodiments, the device 500 may compare the first and second interference profiles with Doppler signatures and/or power signatures that are known or recognized by the device 500. For example, if either of the first and/or second interference profiles represents a pattern of Doppler shifts, the processor 540 may execute the Doppler signature SW module 564 to classify each detected pattern of Doppler shifts as a known or unknown (e.g., null) Doppler signature (e.g., by comparing the detected pattern of Doppler shifts to a set of known Doppler signatures stored in the DS store 561). If either of the first and/or second interference profiles represents a power profile, the processor 540 may execute the power signature SW module 566 to classify each detected power profile as a known or unknown (e.g., null) power signature (e.g., by comparing the detected power profile to a set of known power signatures stored in the PS store 562).

The processor 540 may then execute the object detection SW module 567 to compare the Doppler signature or power signature for the first interference pattern with the Doppler signature or power signature for the second interference pattern to determine whether an object (known or foreign) is present in the wireless channel. If the first and second interference patterns are both classified as Doppler signatures, the processor 540, in executing the object detection SW module 567, may determine a representative Doppler signature among the respective Doppler signatures for the first and second interference profiles (e.g., as described above with respect to FIG. 4). The representative Doppler signature may indicate whether a known or foreign object is present in the wireless channel (e.g., depending on whether the representative Doppler signature is a known value or a null value).

Similarly, if the first and second interference patterns are both classified as power signatures, the processor 540, in executing the object detection SW module 567, may determine a representative power signature among the respective power signatures for the first and second interference profiles (e.g., as described above with respect to FIG. 4). The representative power signature may thus indicate whether a known or foreign object is present in the wireless channel (e.g., depending on whether the representative power signature is a known value or a null value).

If the first interference pattern is classified as a Doppler signature and the second interference pattern is classified as a power signature (or vice-versa), the processor 540, in executing the object detection SW module 567, may determine a number of additional parameters for the detected object (e.g., as described above with respect to FIG. 3). For example, with reference to Table 1, the combination of the Doppler signature and the power signature may indicate: whether the object is known or foreign, whether the object is moving or stationary, and/or the relative distance or position of the object.

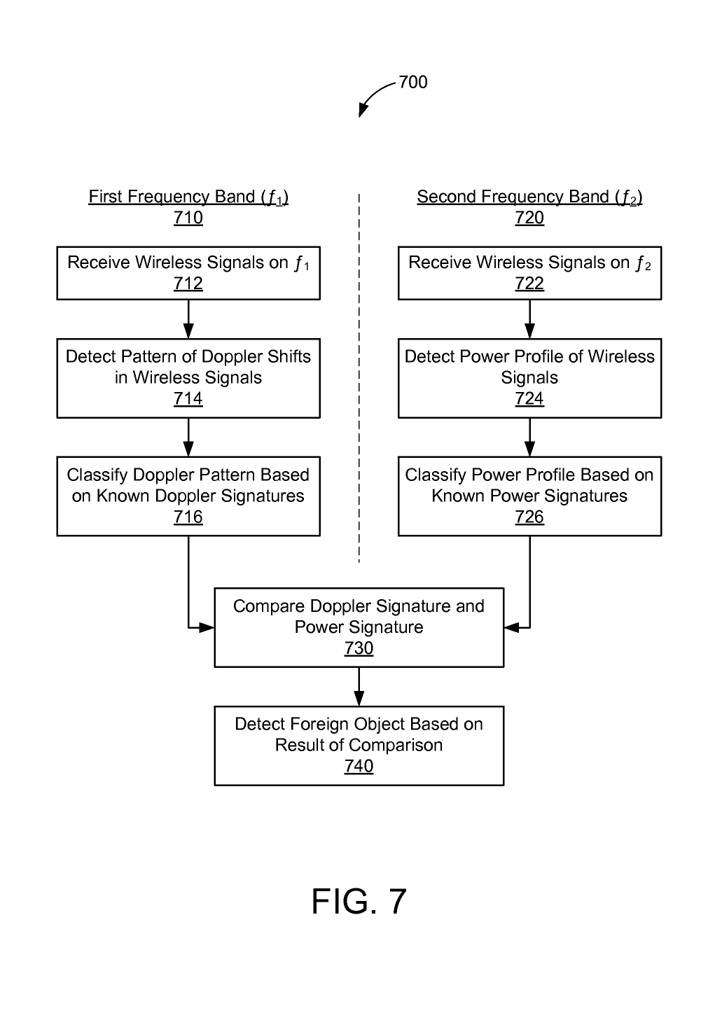

FIG. 7 shows a flowchart depicting an example operation 700 for detecting a foreign object by combining different interference profiles for received wireless signals. With reference, for example, to FIG. 3, the operation 700 may be performed by the multi-frequency object detector 300 to detect the presence of foreign objects in a wireless channel. In some aspects, the operation 700 may include a first sub-operation 710 corresponding to a first frequency band f₁, and may include a second sub-operation 720 corresponding to a second frequency band f₂.

The object detector 300 receives a first set of wireless signals on the first frequency band f₁ (712). For some embodiments, the first set of wireless signals may correspond to conventional Wi-Fi communication signals transmitted by one or more devices on the first frequency band f₁ (e.g., the 2.4 GHz frequency band). For other embodiments, the first set of wireless signals may correspond to reflected Doppler radar signals transmitted on the first frequency band f₁ (e.g., the 2.4 GHz frequency band) by a wireless device on which the object detector 300 resides.

The object detector 300 detects a pattern of Doppler shifts in the first set of received wireless signals (714). For example, if the first set of wireless signals correspond to conventional Wi-Fi communication signals, the Doppler pattern detector 312 may detect a pattern of Doppler shifts 303 based on data communicated in the received wireless signals 301 (e.g., preamble and/or payload information). Alternatively, if the first set of wireless signals correspond to Doppler radar signals, the Doppler pattern detector 312 may detect the pattern of Doppler shifts 303 based on changes in the round-trip times and/or phases between successive wireless signals in each set of received wireless signals 301.

The object detector 300 then classifies the detected Doppler pattern based on known Doppler signatures (716). For example, the Doppler signature classifier 314 may compare the Doppler pattern 303 with a set of predetermined Doppler signatures 311 that are known or recognized by the object detector 300. As described above, with respect to FIG. 3, each known Doppler signature 311 may be associated with a particular state or condition of a user's home (e.g., empty house, house with user present, house with family members present, house with guests present, etc.). In example embodiments, the Doppler signature classifier 314 may output a Doppler signature 305 corresponding to the known Doppler signature 311 that matches the detected Doppler pattern 303. If there are no known Doppler signatures 311 that match the detected Doppler pattern 303, the Doppler signature classifier 314 may output a null value for the Doppler signature 305.

Further, the object detector 300 receives a second set of wireless signals on the second frequency band f₂ (722). For some embodiments, the second set of wireless signals may correspond to UWB communication signals transmitted by one or more devices on the second frequency band f₂ (e.g., the 60 GHz frequency band). For other embodiments, the second set of wireless signals may correspond to reflected UWB radar signals transmitted on the second frequency band f₂ (e.g., the 60 GHz frequency band) by the wireless device on which the object detector 300 resides.

The object detector 300 detects a power profile of the second set of received wireless signals (724). As described above, UWB signals (e.g., UWB communication signals and UWB radar signals) are transmitted as a series of narrow pulses (e.g., a delta function). Thus, the power profile detector 322 may detect a power profile 304 of the received wireless signals by measuring the power and/or energy levels of the series of pulses (e.g., in the time domain).

The object detector 300 then classifies the detected power profile based on known power signatures (726). For example, the power signature classifier 324 may compare the power profile 304 with a set of predetermined power signatures 321 that are known or recognized by the object detector 300. As described above, with respect to FIG. 3, each known power signature 321 may be associated with a particular state or condition of a user's home (e.g., empty house, house with user present, house with family members present, house with guests present, etc.). In example embodiments, the power signature classifier 324 may output a power signature 306 corresponding to the known power signature 321 that matches the detected power profile 304. If there are no known power signatures 321 that match the detected power profile 304, the power signature classifier 324 may output a null value for the power signature 306.

After a Doppler signature and a power signature have been determined, the object detector may compare the Doppler signature and the power signature (730) and detect the presence of a foreign object in the wireless channel based on a result of the comparison (740). In example embodiments, the object detection logic 330 may determine whether the wireless channel is in a known state (e.g., indicating that the user's house is “safe”) or an unknown state (e.g., indicating that there are may be a potential intruder or unknown person inside the user's home). For example, the results of the determination may be summarized by Table 1, above.

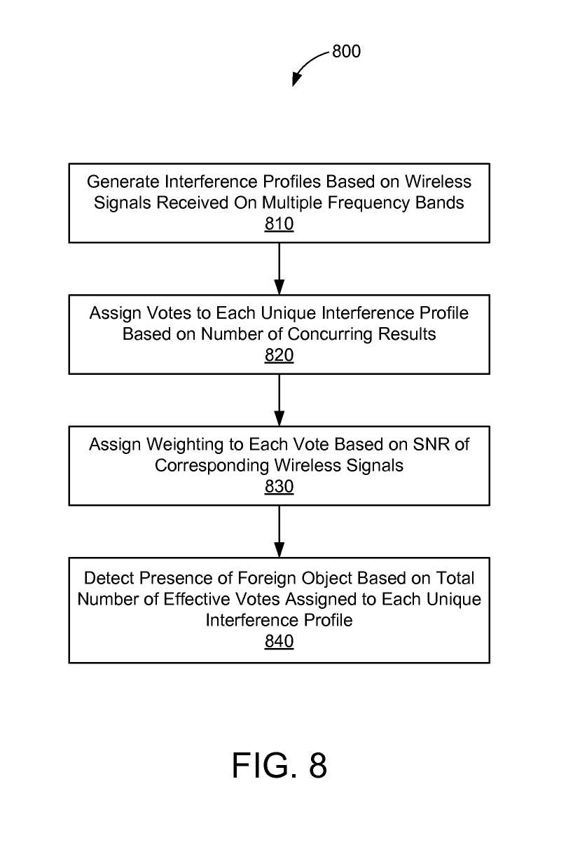

FIG. 8 shows a flowchart depicting an example operation 800 for detecting a foreign object based on a weighted vote among wireless signals received on multiple frequencies. With reference, for example, to FIG. 4, the operation 800 may be performed by the wireless device 410 to detect the presence of an interfering object 401 in the wireless network 450 based on wireless signals 411-413 received from respective wireless devices 420-440 operating on different frequency bands f₁-f₃.

The wireless device 410 first generates a number of interference profiles based on wireless signals received on multiple frequency bands (810). For example, depending on the relative positions of the wireless devices 420-440, their respective operating frequencies f₁-f₃, and/or channel conditions (e.g., noise, interference, etc.), the wireless signals 411-413 received by the wireless device 410 may not all exhibit the same interference profile. In the example of FIG. 4, the wireless signals 411 and 413 transmitted by wireless devices 420 and 440, respectively, exhibit a first unique interference profile (IP_A), whereas the wireless signals 412 transmitted by wireless device 430 exhibit a second unique interference profile (IP_B). In example embodiments, the interference profiles IP_A and IP_B may represent different Doppler signatures or different power signatures (and thus different object recognition results) for the interfering object 401.

The wireless device 410 assigns a vote to each unique interference profile based on a number of concurring results (820). For example, each vote may be “cast by” or otherwise associated with the particular wireless device 420, 430, or 440 that transmitted the set of wireless signals (e.g., wireless signals 411, 412, or 413, respectively) that exhibited the interference profile. In the example of FIG. 4, the first interference profile IP_A receives two votes (e.g., by wireless devices 420 and 440), whereas the second interference profile IP_B receives only one vote (e.g., by wireless device 430).

The wireless device 410 may further assign a weighting to each vote based on the SNR of the corresponding wireless signals (830). For example, signal interference (e.g., represented by Doppler shifts or measured power) may be more accurately and/or reliably detected in wireless signals with higher SNR values. Thus, a vote associated with a higher-SNR wireless signal may be weighted more heavily than a vote associated with a lower-SNR wireless signal. In the example of FIG. 4, wireless signals 411 and 413 have substantially the same SNR (e.g., SNR1=SNR3), whereas wireless signals 412 have a higher SNR than both wireless signals 411 and 413 (e.g., SNR2>SNR1 and SNR2>SNR3). Thus, the votes cast by wireless devices 420 and 440 may be weighted equally, while the vote cast by wireless device 430 may be weighted more heavily.

Finally, the wireless device 410 may detect the presence of a foreign object based on the total number of effective votes assigned to each unique interference profile (840). In example embodiments, the wireless device 410 may select the interference profile IP_A or IP_B that receives the highest effective number of votes as the representative interference profile for the interfering object 401. The weighting metric may directly impact the “effective” number of votes for a particular interference profile, for example, such that a more heavily weighted vote counts for a greater number of effective votes than a less-heavily weighted vote. In the example of FIG. 4, and with reference to Table 2, 4 votes are effectively cast for the first interference profile IP_A, whereas only 3 votes are effectively cast for the second interference profile IP_B. Thus, the wireless device 410 may select the first interference profile IP_A as the representative interference profile for the interfering object 401.

Upon determining the representative interference profile (e.g., which may be a representative Doppler pattern or a representative power profile), the wireless device 410 may classify the corresponding pattern of Doppler shifts or power profile as a respective Doppler signature or power signature (e.g., as described above with respect to FIGS. 3 and 7). In example embodiments, the wireless device 410 may determine whether the detected object 401 is a known object or a foreign object based on whether the Doppler signature or power signature classification is known or unknown to the wireless device 410.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of object detection in a wireless network, the method being performed by a wireless communications device in the wireless network and comprising:
receiving a first set of wireless signals on a first frequency band;
receiving a second set of wireless signals on a second frequency band;
generating a first interference profile for the wireless network based on signal interference in the first set of wireless signals;
generating a second interference profile for the wireless network based on signal interference in the second set of wireless signals; and
detecting a presence of an object in the wireless network based at least in part on the first interference profile and the second interference profile.

2. The method of claim 1, wherein the first set of wireless signals correspond with wireless local area network (WLAN) signals, and wherein the second set of wireless signals correspond with ultra-wideband (UWB) signals.

3. The method of claim 2, wherein the first interference profile is based on a pattern of Doppler shifts in the first set of wireless signals.

4. The method of claim 2, wherein the second interference profile is based on a power profile of the second set of wireless signals.

5. The method of claim 2, further comprising:
determining whether the object is moving or stationary based on the first interference profile and the second interference profile.

6. The method of claim 1, further comprising:
receiving a third set of wireless signals on a third frequency band; and
generating a third interference profile for the wireless network based on signal interference in the third set of wireless signals.

7. The method of claim 6, wherein detection of the object in the wireless network is based on the first, second, and third interference profiles.

8. The method of claim 7, further comprising:
applying a weighting metric to each of the first, second, and third interference profiles, wherein the weighting metric is based at least in part on a signal quality of the first, second, and third sets of wireless signals.

9. The method of claim 6, wherein the first frequency band is a 2.4 GHz frequency band, the second frequency band is a 60 GHz frequency band, and the third frequency band is a 5 GHz frequency band.

10. A wireless communications device, comprising:
a transceiver to exchange wireless signals with other wireless devices in a wireless network;
one or more processors; and
a memory storing instructions that, when executed by the one or more processors, cause the wireless communications device to:
receive a first set of wireless signals on a first frequency band;
receive a second set of wireless signals on a second frequency band;
generate a first interference profile for the wireless network based on signal interference in the first set of wireless signals;
generate a second interference profile for the wireless network based on signal interference in the second set of wireless signals; and
detect a presence of an object in the wireless network based at least in part on the first interference profile and the second interference profile.

11. The wireless communications device of claim 10, wherein the first set of wireless signals correspond with wireless local area network (WLAN) signals, and wherein the second set of wireless signals correspond with ultra-wideband (UWB) signals.

12. The wireless communications device of claim 11, wherein the first interference profile is based on a pattern of Doppler shifts in the first set of wireless signals.

13. The wireless communications device of claim 11, wherein the second interference profile is based on a power profile of the second set of wireless signals.

14. The wireless communications device of claim 11, wherein execution of the instructions further causes the wireless communications device to:
determine whether the object is moving or stationary based on the first interference profile and the second interference profile.

15. The wireless communications device of claim 10, wherein execution of the instructions further causes the wireless communications device to:
receive a third set of wireless signals on a third frequency band; and
generate a third interference profile for the wireless network based on signal interference in the third set of wireless signals.

16. The wireless communications device of claim 15, wherein detection of the object in the wireless network is based on the first, second, and third interference profiles.

17. The wireless communications device of claim 16, wherein execution of the instructions further causes the wireless communications device to:
apply a weighting metric to each of the first, second, and third interference profiles, wherein the weighting metric is based at least in part on a signal quality of the first, second, and third sets of wireless signals.

18. A wireless communications device, comprising:
means for receiving a first set of wireless signals on a first frequency band;
means for receiving a second set of wireless signals on a second frequency band;
means for generating a first interference profile for the wireless network based on signal interference in the first set of wireless signals;
means for generating a second interference profile for the wireless network based on signal interference in the second set of wireless signals; and
means for detecting a presence of an object in the wireless network based at least in part on the first interference profile and the second interference profile.

19. The wireless communications device of claim 18, wherein the first set of wireless signals correspond with wireless local area network (WLAN) signals, and wherein the second set of wireless signals correspond with ultra-wideband (UWB) signals.

20. The wireless communications device of claim 19, wherein the first interference profile is based on a pattern of Doppler shifts in the first set of wireless signals.

21. The wireless communications device of claim 19, wherein the second interference profile is based on a power profile of the second set of wireless signals.

22. The wireless communications device of claim 19, further comprising:
means for determining whether the object is moving or stationary based on the first interference profile and the second interference profile.

23. The wireless communications device of claim 18, further comprising:
means for receiving a third set of wireless signals on a third frequency band; and
means for generating a third interference profile for the wireless network based on signal interference in the third set of wireless signals, wherein detection of the object in the wireless network is based on the first, second, and third interference profiles.

24. The wireless communications device of claim 23, further comprising:
means for applying a weighting metric to each of the first, second, and third interference profiles, wherein the weighting metric is based at least in part on a signal quality of the first, second, and third sets of wireless signals.

25. A non-transitory computer-readable medium storing instructions that, when executed by one or more processors of a wireless communications device in a wireless network, cause the wireless communications device to:
receive a first set of wireless signals on a first frequency band;
receive a second set of wireless signals on a second frequency band;
generate a first interference profile for the wireless network based on signal interference in the first set of wireless signals;
generate a second interference profile for the wireless network based on signal interference in the second set of wireless signals; and
detect a presence of an object in the wireless network based at least in part on the first interference profile and the second interference profile.

26. The non-transitory computer-readable medium of claim 25, wherein the first set of wireless signals corresponds with wireless local area network (WLAN) signals, and wherein the second set of wireless signals includes ultra-wideband (UWB) signals.

27. The non-transitory computer-readable medium of claim 26, wherein the first interference profile is based on a pattern of Doppler shifts in the first set of wireless signals.

28. The non-transitory computer-readable medium of claim 26, wherein the second interference profile is based on a power profile of the second set of wireless signals.

29. The non-transitory computer-readable medium of claim 26, wherein execution of the instructions further causes the wireless communications device to:
determine whether the object is moving or stationary based on the first interference profile and the second interference profile.

30. The non-transitory computer-readable medium of claim 29, wherein execution of the instructions further causes the wireless communications device to:
receive a third set of wireless signals on a third frequency band; and
determine a third interference profile for the wireless network based on signal interference in the third set of wireless signals, wherein detection of the object in the wireless network is based on the first, second, and third interference profiles.
